(19) United States
(12) Patent Application Publication
(10) Pub. No.: US 2026/0009744 A1
(43) Pub. Date: Jan. 8, 2026

(54) SAMPLE CHANGER FOR X-RAY DEVICES

(71) Applicant: Bruker Belgium N.V., Kontich (BE)

(72) Inventors: Koen VERELST, Brasschaat (BE); Michael KRUMM, Antwerpen (BE)

(21) Appl. No.: 19/227,988

(22) Filed: Jun. 4, 2025

(30) Foreign Application Priority Data
Jul. 3, 2024 (EP) 24186280.4

(51) Int. Cl. G01N 23/04; G01N 35/04

(52) U.S. Cl. CPC G01N 23/04; G01N 35/04; G01N 2035/0441; G01N 2223/309

(57) ABSTRACT

A sample changer for an X-ray analysis device comprises a tray rotatable around a rotation axis Y and having a plurality of sample positions in a circular pattern, the tray being driven by a motor. The sample changer comprises a telescopic arm having a drive system designed to perform a linear translatory back and forth movement in a Z-direction perpendicular to the rotation axis Y with a gripper arranged on the telescopic arm designed to pick a sample from the tray and to carry the sample to a measurement chamber in the X-ray device and back. The telescopic arm is arranged in an XZ plane perpendicular to the rotation axis Y and is radially directed from the center to an outer circumference of the tray. This mechanism allows pre-selecting and positioning the samples next to a loading opening in order to facilitate a less time-consuming measurement.

### BACKGROUND OF THE INVENTION

### Field of the Invention

The invention relates to an X-ray analysis device with a sample changer comprising a tray rotatable around a rotation axis Y and having a plurality of sample positions in a circular pattern, the rotatable tray being driven by a motor to rotate the tray around the rotation axis Y of the sample position. X-ray analysis devices of this kind are shown in the BRUKER-brochure “SKYSCAN 1272 CMOS Edition” or in the brochure “SKYSCAN 1275”.

### Description of the Related Art

In general, the present invention relates to the technical field of X-ray analysis for providing fast routine examinations of samples of different materials. Thereby, methods employing X-ray fluorescence, X-ray diffractometry or other X-ray analysis methods are used for studying the features of material samples. The latter can be solid material in massive or pulverized form, but also fluids in appropriate containers.

A particularly powerful technique of X-ray analysis is 3D X-ray microscopy (3D XRM), also called “microCT” as described, e.g., in the aforementioned brochures. MicroCT is one of the most advanced methods of getting 3D insights into samples of any material, shape, or size with little to no sample preparation. Conventional microscopy uses light or an electron beam to directly image a sample by refocusing the radiation passing through the sample, and alternative microscopy techniques such as Atomic Force Microscopy (“AFM”) use other sensors to probe the sample surface. These techniques can provide detailed local 2D images of surface or near-surface structures or properties. X-ray microscopy, however, can also image the 3D internal structure, measure the whole sample at once and avoid extensive sample preparations that may alter or even destroy the sample. In particular the “SkyScan1275” device mentioned above is specially designed for fast scanning with high quality results crucial for scientific research and industrial applications such as quality control or production process monitoring.

For these purposes, the generic X-ray analysis devices must provide a high level of automation. In such routine examinations a great number of samples have to be measured in short periods of time. Hence, sample changer facilities for selecting the sample to be actually measured out of a plurality of other samples to be examined at a different time are essential for a fast transport and correct positioning of the sample selected for measurement.

An early and comparatively slowly working sample changer for an X-ray analysis device is described in patent document DE 198 51 501 C1. Here, different ferromagnetic sample holders are gripped by means of an electromagnet and are de-magnetized after being put into their measuring position.

Patent document U.S. Pat. No. 6,111,930 A discloses a linear automatic sample changer for an X-ray diffractometer. There is no rotating sample tray and no rotation of the sample is possible.

Patent document CN 113960081 A shows another linear sample holder providing a vertical lift of a sample to its measurement position. Again, there is no rotating sample tray and no rotation of the sample is possible.

Patent document CN 218995266 U discloses a rotating sample tray. Samples are put onto a rotating plate, but are not picked and transferred to a measurement chamber. The sample picking is done from the top. No means such as an end effector inside the rotating sample changer for loading the samples into the measuring device is provided.

Patent document CN 106383134 A describes a sample changer with a platform that rotates and brings a sample into the measuring position. No picking and placing of the sample is provided.

In patent document US D715,958 S, again sample picking is performed from the top of the device. No end effector inside the sample changer is disclosed.

Patent document CN 103344659 A describes a vertical drop of the sample to some sort of transfer tube. Again, no end effector inside the sample changer is disclosed. Also, there are no rotating elements provided in this device.

Patent document US 2014/0123738 A1 discloses a sample changer, which can receive sample holders. The changer comprises a circular tray in which there are through holes to receive the holders. It is associated with a lifting column actuated by a motor vertically moving the circular tray. A second motor rotates the circular tray. The circular tray is mobile in rotation and in vertical translation, but the document is silent about a device for sample feeding. However, the samples are put onto a rotating plate, but are not picked and transferred to a measurement chamber.

The existing Bruker micro-CT sample changer for the “SkyScan 1272” and “SkyScan 1275” already mentioned above describes a generic device relying on a mechanical principle to ensure sample handling and imaging. At its core, the system features a robotic arm mechanism, designed for precision and reliability. This robotic arm is equipped with specialized end effectors adept at securely grasping various sample holders. The arm's movements are determined by a programmed sequence, guiding it between the sample loading tray and the imaging chamber. Within the imaging chamber, the “SkyScan 1272” or “SkyScan 1275” performs a scan of the samples. The robotic arm places each sample in the optimal position for imaging, ensuring consistent results across multiple scans. This automation significantly reduces the need for manual intervention, thereby freeing up valuable time for researchers to focus on data analysis and interpretation. The sample changer is designed as a top loader-meaning the rotating disc/tray is inside a compartment put onto the top of the instrument.

The SkyScan sample changers execute the following sequence:
Rotate the sample disc/tray to the requested position
Pick the sample holder (with sample on top)
Retract the robotic arm from the disc/tray
Move the robotic arm down
Move the rotation stage to the handover position
Open the automatic door of the instrument
Insert the sample onto the rotation stage with the robotic arm
Drop the sample
Retract the robotic arm
Close the automatic door of the instrument
Perform the scan

Downside of this known mechanism:
Instrument blocks entrance to, and view into, the micro-CT system's sample chamber, because the lifting mechanism covers the instrument door
Bulky instrument (lift stage)
Not easy to equip the sample changer with samples if mounted on top of the instrument
Difficult to install
Complex movements, specimen trajectory from sample tray to inspection chamber
Long travel with the lift stage, taking a long time to feed samples.

### SUMMARY OF THE INVENTION

The present invention provides a generic and compact sample changer, which is, in particular, intended for XRM (X-Ray Microscopy) benchtop devices, and which, in contrast to the known sample changers, can be loaded from the front side. The novel sample changer should be easy to use and easily applied in a wide variety of locations through its small and compact construction. Further, the sample changer should comprise a comparatively non-complex mechanism. The device should also provide the possibility of pre-selecting and positioning the samples next to a loading opening in order to facilitate a less time-consuming measurement.

This is achieved, in accordance with the present invention, by providing a sample changer with a telescopic arm having a drive system designed to perform a linear translatory back and forth movement in a Z-direction perpendicular to the rotation axis Y with an end effector arranged on the telescopic arm designed to pick up a sample from the tray and to carry the sample to a measurement chamber in the X-ray analysis device and back. The telescopic arm is arranged in an XZ plane perpendicular to the rotation axis Y being radially directed from the center to an outer circumference of the rotatable tray.

The present invention provides a sample changer that has particular advantage for microCT desktop systems. Relative to “carousel” sample changers of the prior art, it has the advantage that the door of the instrument itself is not covered leaving no access to the specimen chamber when the sample changer is installed.

Further, the sample changer comprises a non-complex mechanism with a simple telescopic arm performing a linear movement only and a rotatable tray for the selection of the samples.

The sample changer according to the present invention offers a great number of several significant advantages:

Increased Efficiency-The sample changer automates the process of loading and positioning samples for imaging, significantly reducing the time and effort required by researchers. This increased efficiency allows for higher throughput, enabling the imaging of more samples in a shorter amount of time.

Consistency and Accuracy-By utilizing a telescopic arm and programmed sequences, the novel sample changer ensures consistent and accurate positioning of samples within the imaging chamber. This consistency is crucial for obtaining reliable and reproducible results across multiple scans. In contrast to the state of the art, there is no need for a precision-manufactured robotic arm that has to perform a sequence of different movements to load the sample.

Minimized Risk of Sample Damage-The automated handling provided by the novel sample changer reduces the risk of sample damage or mishandling that may occur during manual loading and positioning. This is especially important when dealing with delicate or valuable samples.

Customization and Flexibility-Sample changers often offer options for customizable sample positioning and imaging configurations, allowing researchers to tailor the system to their specific experimental needs. This flexibility enables a wide range of applications across various fields, from materials science to biology and beyond.

Unattended Operation-With the novel sample changer in place, the user can initiate imaging runs and leave the system to operate unattended, freeing up their time for other tasks. This is particularly beneficial for long-term experiments or overnight scans.

Streamlined Workflow-The integration of the novel sample changer into the micro-CT system streamlines the overall imaging workflow, reducing the need for manual intervention and simplifying the process from sample preparation to data acquisition.

Overall, the sample changer according to the present invention enhances the capabilities of micro-CT systems by improving efficiency, accuracy, and flexibility, ultimately empowering researchers to conduct more sophisticated experiments and obtain higher-quality data.

Further significant advantages of the present invention:
Compact design (pick & place device inside the carousel/circular sample tray)
   telescopic arm to extend reach
   carousel/circular tray rotates around telescopic arm
Less complex movements
   Telescopic arm with an end effector to pick and move sample placed inside circumference of carousel/circular sample tray
   telescopic arm is static—no rotation, no lift—only extends to take out sample and retracts to collect sample along one horizontal static axis
   carousel/circular tray is fixed in vertical direction (not lifted)
   integrated mechanism to lift the sample in pick up position to be picked by the telescopic arm

Easy to equip the sample changer with samples; tray mounted in front of the instrument
Easy to install
Short travel taking only little time

As the measurement time can be relatively long during CT measurement, the novel sample changer can pre-sort or position the sample carriers so that the subsequent loading step can be carried out more quickly. This is possible because the sample changer according to the invention can move independently of the closed measuring chamber. The rotational sample tray and the telescopic arm are outside the measuring chamber and can place the samples in different positions on the tray.

The present invention uses a compact pick & place mechanism mounted inside a circular sample tray, and a front loader to feed samples into the main system, which still allows access to the sample chamber when mounted on the main system. This concept eliminates the need for a lift mechanism blocking access to the sample changer and impairing manual single scan operation.

The sample changer can easily be installed onto the X-ray device without an additional alignment procedure. The changer can also be retrofitted to the X-ray device.

In particular embodiments of the invention, one end of the telescopic arm is arranged essentially in the center of the rotatable tray starting from the rotation axis Y of the sample position pattern, and the drive system is arranged along the telescopic arm in a Z-direction perpendicular to the rotation axis Y.

The telescopic arm crosses the center of the tray but the movement does not necessarily originate in the center. Positioning the telescopic arm in the middle of the carousel is space-saving allowing for a compact design. Depending on the shape of the arm, the end effector can move above the tray, or the tray has a loading slot (as described below in detail) which allows the telescopic arm to pass through.

A class of advantageous embodiments of the present invention is characterized in that the sample changer is arranged in front of the X-ray analysis device such that the measurement chamber is linearly accessible in the Z-direction with the telescopic arm, preferably through a shutter.

Thereby, the sample changer is adapted for use in combination with an X-ray device which is provided with a device door or a shutter to prevent X-radiation leaking out of the device. Preferably during loading and unloading of the samples into the CT device, the X-ray source will be shut down. Optionally a shutter could be arranged for the case of fragile X-ray sources that need to stay on during loading/unloading.

In a further development of this class of embodiments, the sample changer comprises at least two fixing means, in particular anchors, arranged on the bottom plate which are designed to engage with counterparts, in particular pins, on the bottom plate of the X-ray analysis device in a linear movement of the sample changer to the X-ray analysis device, and a latching element to fasten the sample changer to the X-ray analysis device.

Installation is easy because the novel sample changer's position is defined by three fixed “anchors” underneath the main system in the base plate. The fork-shaped anchors engage in corresponding counter shapes, such as a pin, by a sliding movement. After the engagement, the sample changer is fixed in position with a latching mechanism. No further alignment procedure is necessary. The existing prior art sample changers have to be aligned each time they are installed.

In another class of comparatively compact and simple embodiments, the sample changer for an X-ray analysis device according to the invention, preferably an X-ray diffractometer or a CT apparatus, is characterized in that the sample changer further comprises a plurality of sample holders for carrying the objects to be analyzed, and designed to fit with the sample positions, whereby the sample positions are protrusions, recesses or through holes in the rotatable tray into which the user can position the samples.

In an exemplary embodiment, the sample changer comprises a pair of clamping jaws with a mechanism for clamping and opening the jaws to releasably lock the sample holder in position on the rotatable tray when the telescopic arm is approaching or retracting. Further, it keeps the sample holders in place, e.g., during the scan when the sample holder is prone to wiggling during rotation of the carousel. The clamping arms are preferably an additional electro-mechanical assembly with automatically driven clamping jaws. This device is preferably mounted onto the rotatable tray.

Also advantageous is a further development of these embodiments, in which the sample holders comprise a circumferential rim or edge into which the telescopic arm can engage to lift the holder, and the end effector has a fork-shape designed to engage the sample holder.

Alternatively or conjointly, in a further advantageous variant of these embodiments, the sample changer further comprises a lifting mechanism for lifting the sample or the sample holder to be picked up by the end effector. This additional lifting mechanism lifts the sample holder of about 1 cm into the pick-up position in which the fork of the telescopic arm can engage.

Also favorable are alternative embodiments of the invention, which are characterized in that in the sample holders comprise a circumferential conical part and the end effector is designed as end effector or pincers that lift the sample holder when pressed together. Here, the fork can be replaced by an end effector and the sample holder is provided with a conical feature, so that the end effector arms squeeze the conical area of the sample holder and it is then automatically lifted by the gripping movement. This means that a separate lifting mechanism is not required. Instead, an end effector is needed to squeeze the arms.

Further beneficial embodiments of the invention are characterized in that the rotating tray comprises a slot in Z-direction allowing the telescopic arm to pass through the slot into the X-ray analysis device. This provides the possibility of pre-selecting and positioning the samples next to the loading slot which is useful for a less time-consuming measurement. Optionally one holding slot can be kept empty, i.e., without a sample holder, to allow the sample changer for advanced loading of the subsequent sample during the measurement time of the previous one.

Also within the scope of the present invention falls a method for performing an X-ray measurement comprising the following steps:
i. providing an X-ray analysis device according to the invention as described above, whereby out of all positions of the rotatable tray of the sample changer and the scan position inside the measurement instrument at least one position is free; and
ii. loading the X-ray analysis device with a sample, starting the measurement, and placing the sample that is to be scanned next on a first side of the input slot and making sure that on the second side of the input slot there is a free position to place the measured sample.

By pre-sorting of the samples close to the input slot, the time to rotate the tray for unloading and loading is minimized.

Also provided is a further development of this method, whereby step ii described above is carried out with the following sub-steps:
1) before the measurement of the first sample,
   a) dialing the rotatable tray to have the first sample to be measured in front of the end effector of the telescopic arm,
   b) picking the first sample and placing it into the X-ray analysis device,
2) starting the measurement of the first sample,
3) during the measurement of the first sample,
   a) dialing the rotatable tray to the position of the subsequent sample (second object) to be measured, picking the sample and putting it into the free first position next to the input slot,
4) after the measurement of the first sample,
   a) picking the first sample from the X-ray analysis device and positioning it in the free position on the second side of the input slot,
   b) dialing the rotatable tray to the first side of the input slot which is filled by the subsequent sample, picking the sample and placing it into the X-ray analysis device,
   c) dialing the rotatable tray to the position next to the second side of the input slot, picking the sample and putting it into a free position on the rotatable tray
5) Repeating steps 1) to 4) until every sample is measured

A preferred variant of this further development comprises an initial step ii.1.1.a) clearing the scan position inside the measurement instrument when it is occupied by a sample other than the first sample to be scanned by picking the sample and put it into the free position on the rotatable tray.

Alternatively or conjointly, a further advantageous variant comprises step

ii.3.1.a): if the position next to a first side of the input slot is not free, dialing the rotatable tray to that position, picking the sample and putting it into a free position on the rotatable tray.

Another variant of the above further embodiment of the invention is characterized by comprising step ii.3.2): if the position next to a second side of the input slot is not free, dialing the rotatable tray to that position, picking the sample and putting it into a free position on the rotatable tray.

Further advantages can be extracted from the description and the enclosed drawings. The features mentioned above and below can be used in accordance with the invention either individually or collectively in any combination. The embodiments mentioned are not to be understood as exhaustive enumeration but rather have exemplary character for the description of the invention.

### BRIEF DESCRIPTION OF THE DRAWINGS

The invention is shown in the drawings and is explained in more detail based on illustrative embodiments. In the drawings:

FIG. 1a shows a isometric view from above of an embodiment of the sample changer for an X-ray analysis device according to the invention;

FIG. 1b shows the sample changer as shown in FIG. 1a, but without a top cap;

FIG. 1c shows the sample changer as shown in FIG. 1b, but without the rotatable tray and its inner and outer casings;

FIG. 1d shows the sample changer as shown in FIG. 1c, but rotated by 90° around a rotation axis Y and without further casing and mounting parts;

FIG. 1e shows the sample changer as shown in FIG. 1b, but the rotatable tray being charged with two sample holders, one of which is gripped by the fork-shaped end effector;

FIG. 1f shows a partial view of the sample changer with clamping arms for the sample holder;

FIG. 2a schematically shows the carousel of the rotary tray in an initial setup position;

FIG. 2b shows the carousel rotated to a position being requested;

FIG. 2c shows the end effector being moved onto the requested sample and the fork of the end effector being lifted;

FIG. 2d shows the end effector being retracted with the requested sample gripped in the fork;

FIG. 2e shows the carousel being rotated to and inserting slot with the requested sample still being gripped in the fork;

FIG. 2f shows insertion of the fork with the requested sample inserted into the measuring area of the X-ray analysis device;

FIG. 2g shows the end effector with the emptied fork being retracted;

FIG. 3a schematically shows an initial setup of the carousel of the rotary tray.

FIG. 3b shows the situation during a measurement of a sample in a measuring position inside the X-ray analysis device.

FIG. 3c shows the beginning of a parking process of the sample.

FIG. 3d shows the grabbing of sample.

FIG. 3e shows rotating of the carousel to the free position of the sample that is currently being scanned.

FIG. 3f shows the parking of the sample on the free position.

FIG. 3g shows the beginning of placing the next sample to scan on the loading position.

FIG. 3h shows the grabbing of the sample with the end effector.

FIG. 3i shows the rotating of the carousel to a loading position while the sample is still in the fork of the end effector.

FIG. 3j shows the parking of the sample on a loading slot.

FIG. 3k shows the beginning of freeing up the unloading position and parking the sample.

FIG. 31 shows the grabbing of the sample with the fork and the lowering of the end effector.

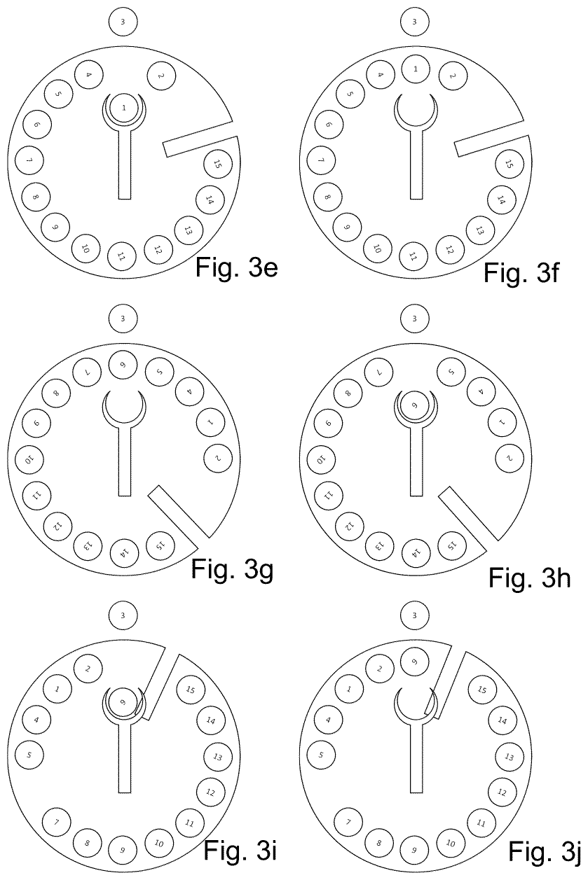

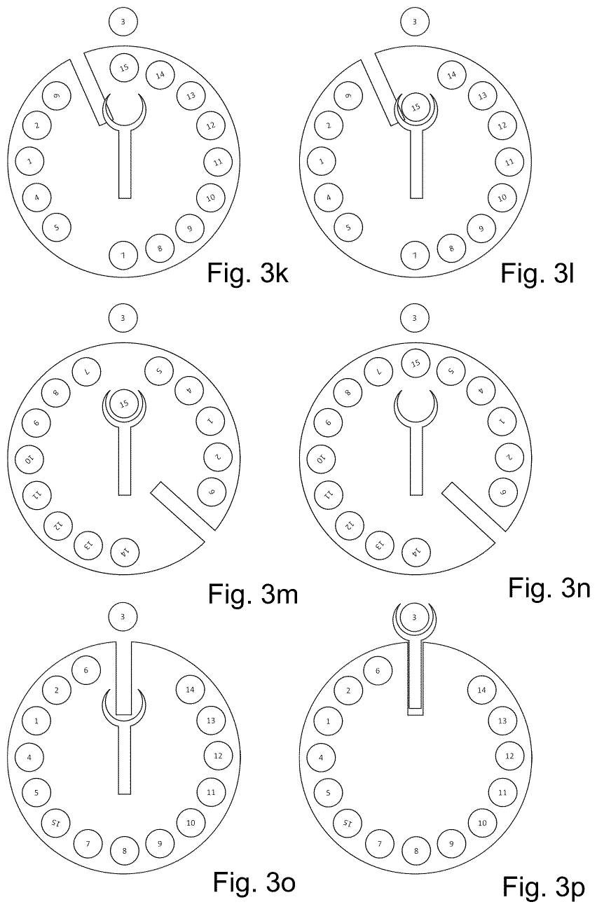

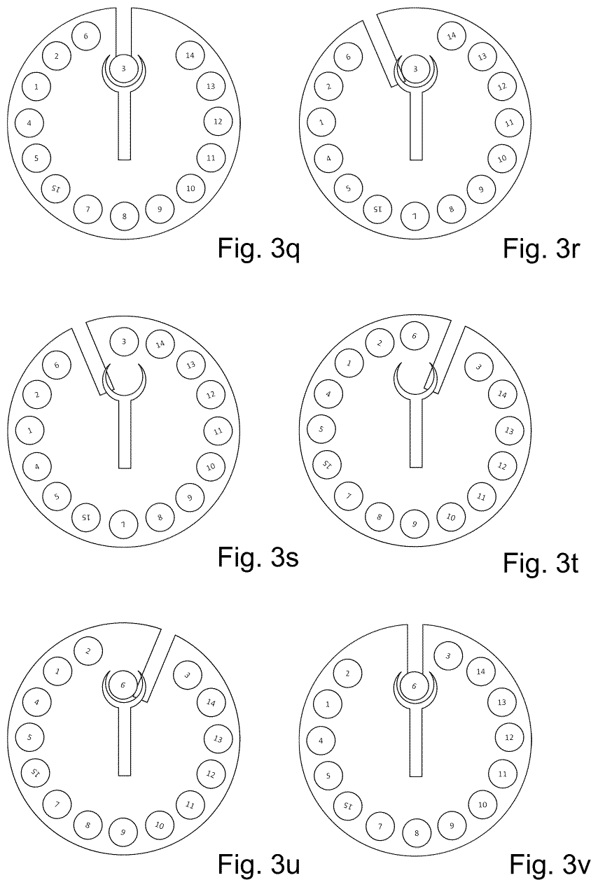

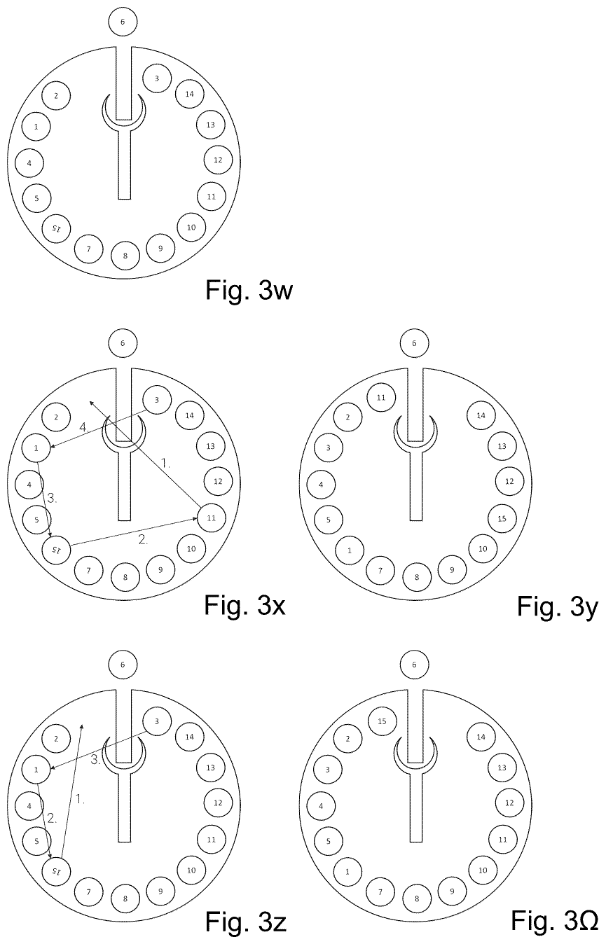

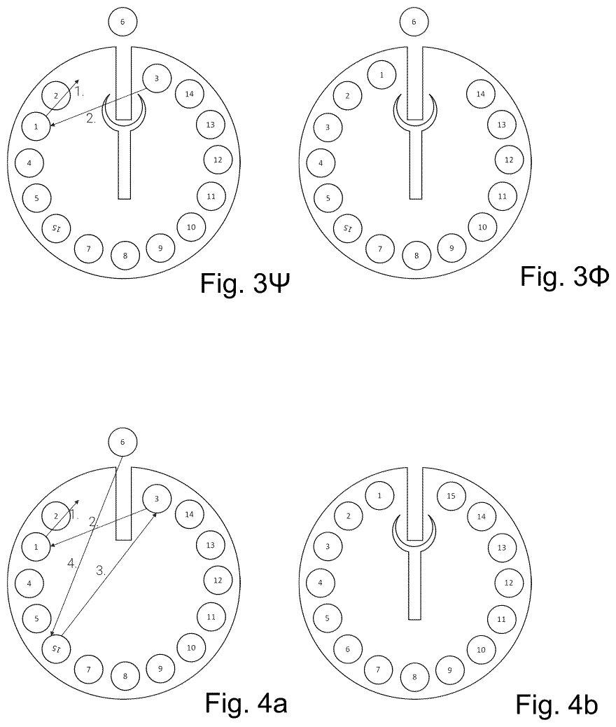

FIG. 3m shows the rotating of the carousel to the original position of the next sample to be scanned.

FIG. 3n shows the parking of the sample on the original position of the next sample to be scanned.

FIG. 3o shows the rotating of the carousel to an inserting position.

FIG. 3p shows the grabbing of the measured sample with the end effector in the measuring position inside the X-ray analysis device.

FIG. 3q shows the lowering of the end effector with the measured sample from the measuring position inside the X-ray analysis device into the carousel.

FIG. 3r shows the rotating of the carousel to the original slot of the sample.

FIG. 3s shows the parking of the recently scanned sample on the unloading position.

FIG. 3t shows the rotating of the carousel to the loading position.

FIG. 3u shows the grabbing of the next sample to be scanned from its parking position.

FIG. 3v shows the rotating of the carousel to the inserting position with the next sample to be scanned still gripped by the fork.

FIG. 3w shows the insertion of sample {6} by the end effector into the measuring position inside the X-ray analysis device for scanning.

FIG. 3x shows schematically a sequence of steps for a certain series of scans.

FIG. 3y shows a sample positioning after performing the steps shown in FIG. 3x.

FIG. 3z shows a procedure alternative to that shown in FIG. 3x.

FIG. 30 shows a sample positioning after performing the steps shown in FIG. 3z.

FIG. 34 shows a procedure alternative to that shown in FIG. 3x for the case in which the sample to be scanned is the one from the loading position.

FIG. 4a shows schematically a series of steps for the carousel of the rotary tray when performing a restauration of the original sequence.

FIG. 4b shows the carousel following performance of the restauration steps.

### DETAILED DESCRIPTION

The present invention is principally concerned with providing improved tools and methods for performing scientific and industrial X-ray investigations. In particular, the invention presents an X-ray analysis device with a sample changer 10 comprising a tray 11 rotatable around a rotation axis Y and having a plurality of sample positions 12 in a circular pattern, the rotatable tray 11 being driven by a motor to rotate the tray 11 around the rotation axis Y of the sample position pattern.

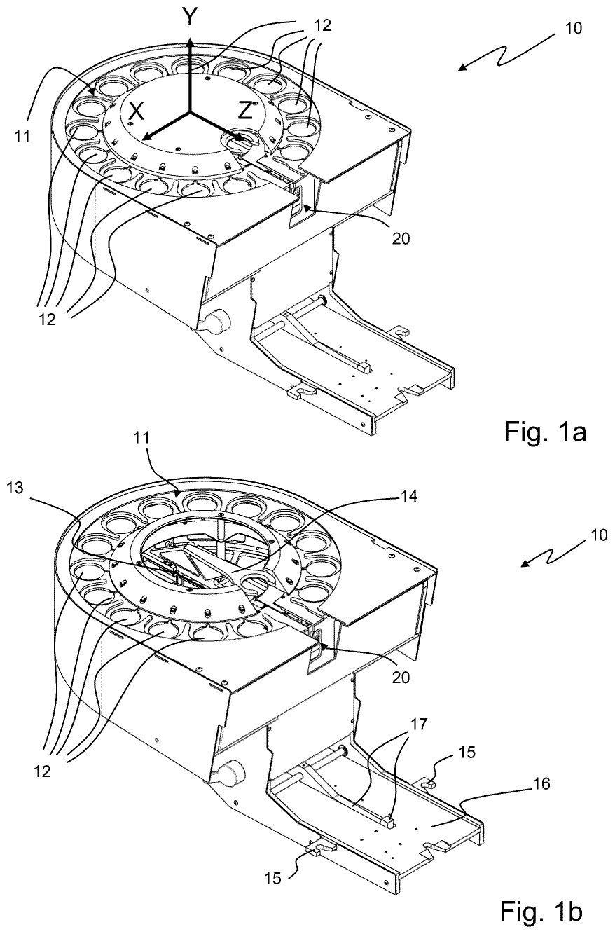

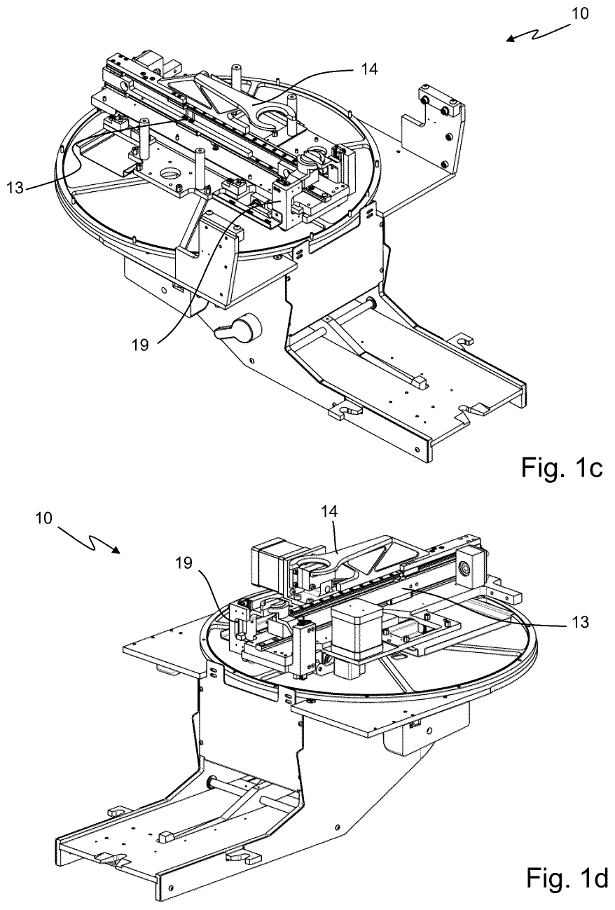

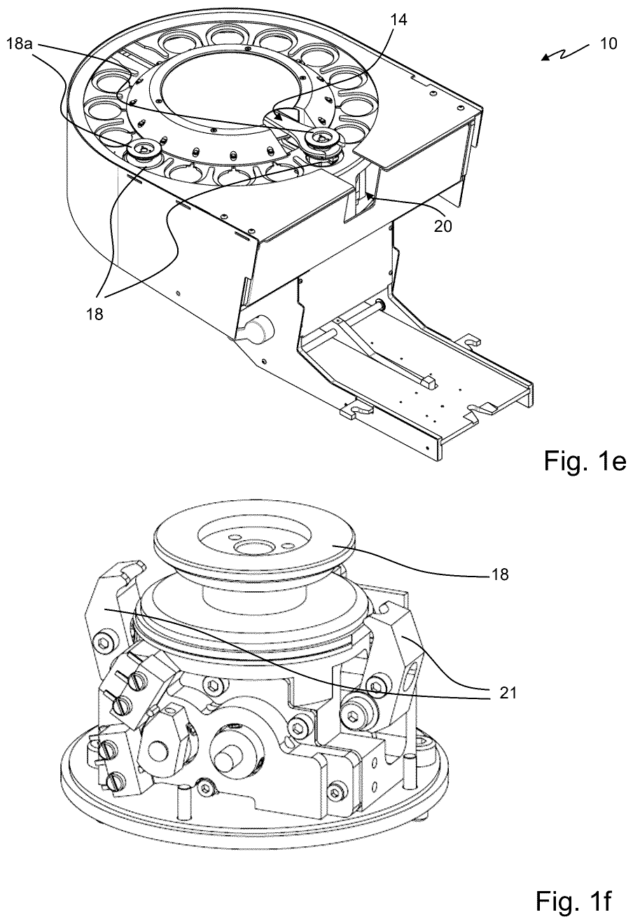

FIGS. 1a through 1f schematically depict an embodiment of the novel sample changer 10 according to the invention comprising a telescopic arm 13 having a drive system designed to perform a linear translatory back and forth movement in a Z-direction perpendicular to the rotation axis Y with an end effector 14 arranged on the telescopic arm 13 designed to pick a sample from the tray 11 and to carry the sample to a measurement chamber in the X-ray analysis device and back. The telescopic arm 13 is arranged in an XZ plane perpendicular to the rotation axis Y being radially directed from the center to an outer circumference of the rotatable tray 11.

The telescopic arm 13 feeds the samples into the instrument. The telescopic arm performs a linear back and forth movement in a single direction which is the loading direction, herein defined as a Z-axis perpendicular to the rotation axis Y. The preferably forked end effector 14 is arranged on top of the telescopic arm 13 and grabs the samples contained in sample holders. One end of the telescopic arm 13 is arranged essentially in the center of the rotatable tray 11 starting from the rotation axis Y of the sample position pattern, and the drive system is arranged along the telescopic arm 13 in the Z-direction.

The sample changer 10 is arranged in front of the X-ray analysis device such that the measurement chamber is linearly accessible in the Z-direction with the telescopic arm 13, preferably through a shutter (not shown in the drawings). Further, the sample changer 10 comprises at least two fixing means 15, in particular anchors, arranged on a bottom plate 16 of the sample changer 10 which are designed to engage with counterparts, in particular pins, on a bottom plate of the X-ray analysis device in a linear movement of the sample changer 10 to the X-ray analysis device, and a latching element 17 to fasten the sample changer 10 to the X-ray analysis device. The latching element 17 is part of a clamping device mounted to the rotary stage 11 of the CT instrument. It is required to make sure that the sample holder is properly fixed inside the scanner.

In FIG. 1e, two sample holders 18 for carrying the objects to be analyzed are depicted, which are designed to fit with the sample positions 12, whereby the sample positions 12 are protrusions or through holes in the rotatable tray 11. The sample holders 18 comprise a circumferential rim or edge 18a and the end effector 14 has a fork-shape designed to engage a sample holder 18. Further, the sample holders 18 can comprise a circumferential conical part (not shown in the drawings) and the end effector 14 can be designed as pincers that lift the sample holder 18 when pressed together.

As shown in FIGS. 1c and 1d, the sample changer 10 may comprise a lifting mechanism 19 for lifting a sample or a sample holder 18 to be picked by the end effector 14. The lifting mechanism 19 lifts the sample preferably about 10 mm in so it can be picked by the fork.

FIGS. 1a, 1b and 1e illustrate an input slot 20 in the Z-direction comprised by the rotatable tray 11 allowing the telescopic arm 13 with the end effector 14 to pass through the input slot 20 into the X-ray analysis device.

As explained above, the sample changer 10 comprises a rotatable tray 11 (also called “carousel”) onto which the sample holders 18 with the samples can be positioned. The rotatable tray 11, or carousel, rotates around the forked end effector 14 which moves only laterally.

Depending on the samples which are used, the tray 11 can be adapted to carry up to, e.g., 60 samples at once, preferably between 10 and 20 samples, with a particularly advantageous embodiment carrying 15 samples. It is advisable to implement several layers to the sample changer 10 for increasing the total amount of samples by stacking them in the sample holder. Depending on how many can be stacked, the number doubles, triples, etc. A double layer would increase the number of samples to 30, a third layer to 45.

The sample tray 11 is basically a disc having holes 12 in which the user can drop sample holders 18 with the samples one by one. There's no border/wall around it—the lid or sample tray cover can be taken off entirely-so samples can be put on the carousel from above or sideways.

In the present embodiment, the rotatable tray 11 is adapted to CT-measurements with 15 holes for receiving sample holders of a diameter of 5 cm. The distance between the sample holders extends to 7.5 cm.

According to the present invention, the device comprises also a telescopic arm 13 for picking the sample holder 18 and for loading it into the X-ray device. The telescopic arm 13 has a forked end effector 14 which fits with the rim of the sample holder 18. By performing a simple translational movement the arm 13 can carry the sample holder 18 from the tray 11 into the measuring chamber of the X-ray device and back.

Thus, the invention presents a novel pick and place device inside the circumference of the circular sample tray having a telescopic arm to feed samples into, and retract samples from, the main instrument. The pick and place device is positioned between the samples and at the level of the sample tray. The drive mechanism can be, e.g., a gear drive or a toothed belt drive with stepper motor or DC motor, but also hydraulic or pneumatic cylinders would be possible.

The lift can be driven by a stepper motor. The mechanism uses a simple worm/wormwheel drive and a lever with cam follower to lift the platform as shown in the drawings.

In an alternative embodiment, the lift can be driven by the motion of the arm/forks. In this case the lift mechanism comprises a platform with a chamfered part, and the platform elevates the lift when the slider with the fork moves towards the sample.

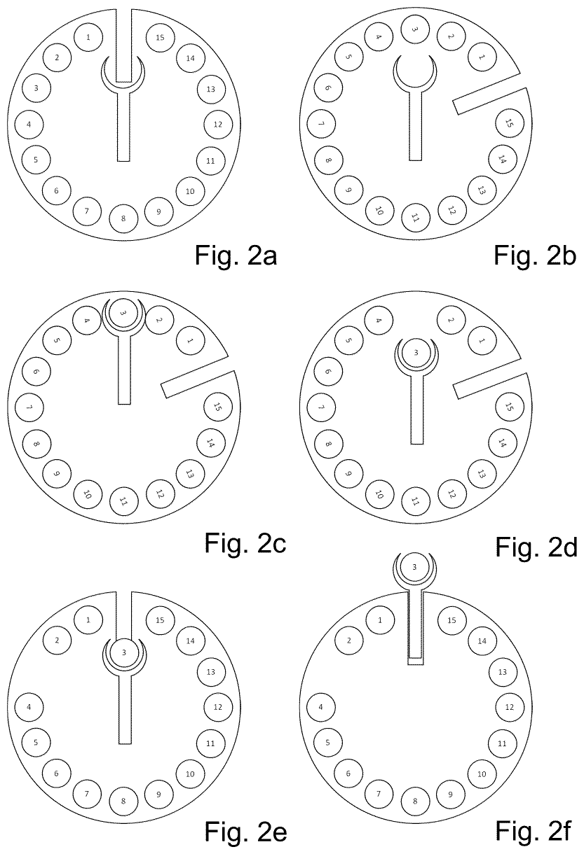

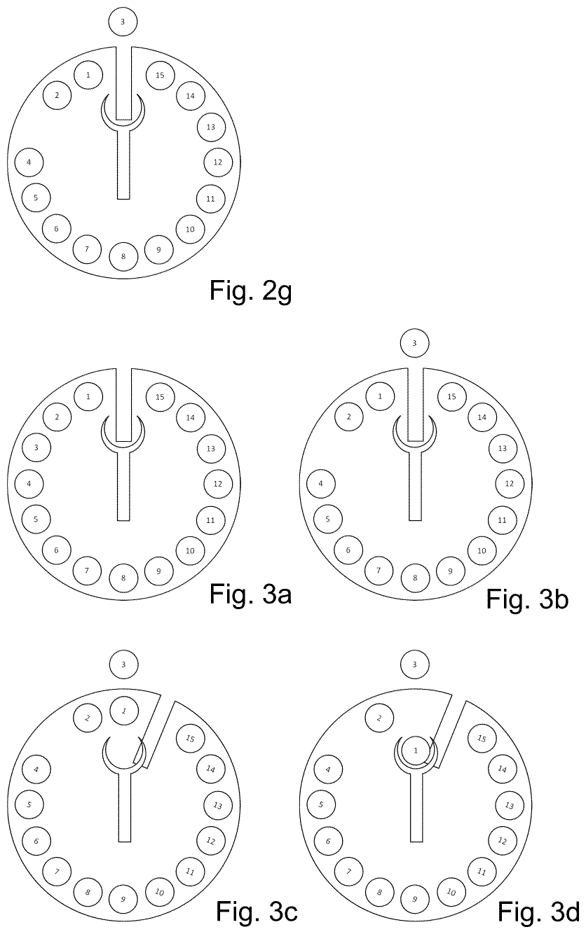

FIGS. 2a through 2g schematically illustrate the loading/unloading of different samples (in this example just 15 samples) by a simple direct loading/unloading process. In this simple direct loading/unloading scheme, samples are picked and loaded/unloaded from their positions “one after the other” as defined in a batch process of the scanner. This process does not necessarily need to be performed in the sequential order of the positions/samples.

FIG. 2a shows the initial setup with the carousel positioned at position [0], i.e., the inserting slot where the gap is. All samples {1-15} are sited in their respective sample positions [1-15].

FIG. 2b shows the carousel rotated to position [3] being currently requested.

FIG. 2c shows the end effector being moved onto sample {3} and the fork of the end effector being lifted.

FIG. 2d shows the end effector being retracted with sample {3} gripped in the fork.

FIG. 2e shows the carousel being rotated to inserting slot [0] with sample {3} still being gripped in the fork.

FIG. 2f shows inserting the fork with sample {3} being inserted into the measuring area of the X-ray analysis device and placing the sample {3} with its sample holder inside the apparatus.

FIG. 2g shows the end effector with the emptied fork being retracted, while the sample {3} is in a measuring position inside the X-ray analysis device; the end effector with its emptied fork is waiting in its position for returning the sample {3} after measurement from the measuring position inside the X-ray analysis device and transporting it back to its initial position [3] on the carousel.

FIGS. 3a through 3o schematically illustrate the loading/unloading of different samples (in this example again just 15 samples) by an advanced and much more efficient loading/unloading process rendered possible by the novel modifications of the sample changer (10) according to the invention. In this advanced loading/unloading scheme, samples are picked and loaded/unloaded from their positions one after the other, again as defined in a batch process of the scanner. Although this process is less simple, it allows for substantially quicker performance of successive scans by sensible use of the (otherwise lost) scanning time for bringing the next sample in an optimal position. The process takes advantage of the following characteristics:
Picking and loading/unloading samples one after the other is quick when positioned near the loading slot.
The further away the sample position is from the inserting slot [0], the more time is required to rotate the carousel, which is extra time the user might not want to spend
Advanced (efficient) loading is enabled by:
   Introducing a loading position and an unloading position.
   While the scan is performed on one sample, the sample changer shuffles the samples on the carousel such that:
   position (unloading) is always free
   position [0] (loading) is always loaded with the next sample to be scanned

FIG. 3a shows the initial setup with the carousel positioned at position [0] where the gap is, position [0] being the loading, unloading and inserting slot. All samples {1-15} are placed in their respective initial positions [1-15].

FIG. 3b shows the situation during a measurement of sample {3} in a measuring position inside the X-ray analysis device. In a simple loading process, the sample changer would just sit idle and wait to undo the loading of sample {3} in a simple way as illustrated in FIG. 2h. Instead of doing that, the apparatus performs the following steps:

FIG. 3c shows the beginning of a parking process of the sample {1} from the loading slot [1] onto the free position of the sample {3} that is currently been scanned and rotating the carousel to loading position [1].

FIG. 3d shows the grabbing of sample {1}. For simplification all necessary sub-steps are left out here for the description in individual movements, i.e., moving the fork onto the sample, lifting the fork and retracting the fork.

FIG. 3e shows the rotating of the carousel to the free position [3] of the sample {3} that is currently being scanned.

FIG. 3f shows the parking of the sample {1} on position [3]. For simplification all necessary sub-steps are left out here for the description in individual movements, i.e., moving the fork onto the slot, lowering the fork, and retracting the fork.

FIG. 3g shows the beginning of placing the next sample {6} to scan on the loading position [1] by rotating the carousel to position [6] of the next sample {6} to be scanned while sample {3} is still in the measuring position inside the X-ray analysis device. In fact, the order in which the samples are scanned is irrelevant and can be configured individually.

FIG. 3h shows the grabbing of the sample {6} with the end effector.

FIG. 3i shows the rotating of the carousel to loading position [1] while the sample {6} is still in the fork of the end effector.

FIG. 3j shows the parking of the sample {6} on the loading slot [0].

FIG. 3k shows the beginning of freeing up the unloading position and parking the sample {15} to position [6] of the next sample {6} to be scanned, while sample {3} is still in the measuring position inside the X-ray analysis device, namely the rotation of the tray to unload sample {15} from its present position [15].

FIG. 31 shows the grabbing of the sample {15} with the fork and lowering the end effector.

FIG. 3m shows the rotating of the carousel to position [6] (the original position of the next sample {6} to be scanned, which is now in position [1]) while the sample {15} is still on the fork of the end effector.

FIG. 3n shows the parking of the sample {15} on position [6].

FIG. 3o shows the rotating of the carousel to the inserting position [0].

FIG. 3p shows the grabbing of the measured sample {3} with the end effector in the measuring position inside the X-ray analysis device. For simplification all necessary sub-steps are left out here for the description in individual movements, i.e., moving the fork via position [0] unto the measuring position, lowering the fork, moving the fork over sample {3}, lifting the fork and retracting the fork.

FIG. 3q shows the lowering of the end effector with the measured sample {3} from the measuring position inside the X-ray analysis device into the carousel.

FIG. 3r shows the rotating of the carousel to position (the original slot of the sample {15}, which is actually parked in position [6]) while the sample {3} is still in the fork of the end effector.

FIG. 3s shows the parking of the recently scanned sample {3} on the unloading position [15].

FIG. 3t shows the rotating of the carousel to the loading position [1], the fork of the end effector being presently empty.

FIG. 3u shows the grabbing of the next sample {6} to be scanned from its parking position in position [1] (the sample {1} being parked in position [3]).

FIG. 3v shows the rotating of the carousel to the inserting position [0] with the next sample {6} to be scanned still gripped by the fork.

FIG. 3w shows the insertion of sample {6} by the end effector into the measuring position inside the X-ray analysis device for scanning. For simplification all necessary sub-steps are left out here for the description in individual movements, i.e., moving the fork via position [0] unto the measuring position of the apparatus, lowering the fork, moving the fork over to the rotary stage, lifting the fork and retracting the fork.

FIG. 3x shows that the next steps are always the same for the following scans:
1. Place the next sample {11} to scan on the loading position [1].
2. Place the sample {15} parked on the position [6] onto the free position of the next sample {11} to be scanned.
3. Place the sample {1} from the parking position [3] onto the position [6] of the sample {6} that is currently been scanned.
4. Free up the unloading position and put the recently scanned sample {3} on its original position [3].

FIG. 3y shows the situation after performing the steps shown in FIG. 3x. The device is ready to put sample {6} to the unloading position and insert the next sample from the loading position [1].

FIG. 3z shows a procedure alternative to FIG. 3x in case the last sample to be scanned is the one from the unloading position [15]:
1. Place the next sample {15} to be scanned (which is currently parked on the slot [6] of the sample {6} that is currently being scanned) on the loading position [1].
2. Place the sample {1} from the parking position [3] onto the position [6] of the sample {6} that is currently been scanned.
3. Free up the unloading position and put the recently scanned sample {3} on its original position [3].

FIG. 3Ω shows the situation after performing the steps shown in FIG. 3z.

FIG. 3ψ shows a procedure alternative to FIG. 3x in case the sample to be scanned is the one from the loading position [1]:
1. Place the next sample {1} to be scanned (which is currently parked on the slot [3] of the sample {3} that was recently scanned) on the loading position [1].
2. Free up the unloading position and put the recently scanned sample {3} on its original position [3]

FIG. 3Φ shows the situation after performing the steps shown in FIG. 3ψ.

FIGS. 4a-4b: After the last measurement we restore the original positions of the samples, i.e.
1. Place sample {1} that was on the loading slot [1] at the beginning of the sequence back to its original position
2. Free up the unloading position and put the recently scanned sample on its original spot [3] which was occupied by the sample from the loading slot
3. Place the next sample from the unloading slot back to its original position
4. Put the last scanned sample that is still in the scanner back to its original position which was occupied by the sample from the unloading slot.

### LIST OF REFERENCE SIGNS

10 sample changer
11 rotatable tray
12 sample positions
13 telescopic arm
14 end effector
15 fixing means
16 bottom plate
17 latching element
18 sample holders
18a rim or edge of sample holders
19 lifting mechanism
20 input slot
21 clamping jaws
X direction perpendicular to Y and Z
Y rotation axis of the tray
Z axis of translatory back and forth movement of the telescopic arm

1. A sample changer for an X-ray analysis device comprising:
a tray rotatable around a rotation axis Y and having a plurality of sample positions in a circular pattern;
a motor that drives the rotatable tray to rotate the tray around the rotation axis Y of the sample position pattern; and
a telescopic arm having a drive system that performs a linear translatory back and forth movement in a Z-direction perpendicular to the rotation axis Y and an end effector arranged on the telescopic arm, the end effector configured to pick a sample from the tray and to carry the sample to a measurement chamber in the X-ray analysis device and to pick a sample from the X-ray analysis device and carry it back to the tray, wherein the telescopic arm is arranged in an XZ plane perpendicular to the rotation axis Y and is radially directed from a center to an outer circumference of the rotatable tray.

2. The sample changer according to claim 1, wherein one end of the telescopic arm is arranged essentially in the center of the rotatable tray starting from the rotation axis Y of the sample position pattern, and the drive system is arranged along the telescopic arm in the Z-direction.

3. The sample changer according to claim 1, wherein the sample changer is arranged in front of the X-ray analysis device such that the measurement chamber is linearly accessible in the Z-direction with the telescopic arm.

4. The sample changer according to claim 3, further comprising at least two fixing means arranged on a bottom plate of the sample changer that engage with counterparts on a bottom plate of the X-ray analysis device in a linear movement of the sample changer to the X-ray analysis device, and a latching element that fastens the sample changer to the X-ray analysis device.

5. The sample changer according to claim 1, further comprising a plurality of sample holders that hold the samples at a plurality of sample positions at which are located protrusions or through holes in the rotatable tray.

6. The sample changer according to claim 5, further comprising a pair of clamping jaws with a mechanism for closing and opening the jaws to releasably lock a first one of the sample holders in position on the rotatable tray when the telescopic arm is approaching or retracting.

7. The sample changer according to claim 5 wherein each of the sample holders comprises a circumferential rim or edge and the end effector has a fork-shape designed to engage a sample holder.

8. The sample changer according to claim 5, further comprising a lifting mechanism for lifting a sample or a sample holder to be picked by the end effector.

9. The sample changer according to claim 5, wherein the sample holders comprise a circumferential conical part and the end effector is an actively driven end effector.

10. The sample changer according to claim 1, wherein the rotatable tray further comprises an input slot in the Z-direction through which the telescopic arm passes into the X-ray analysis device.

11. A method for performing an X-ray measurement using the sample changer according to claim 10, the method comprising:
i) configuring the sample changer such that, out of all sample positions of the rotatable tray and a scan position inside the X-ray analysis device, at least one position is free; and
ii) loading the X-ray analysis device with a sample to be measured, starting a measurement, and placing a subsequent sample to be measured in a first free position on a first side of the input slot, while ensuring that on a second side of the input slot there is a second free position to place a measured sample.

12. The method according to claim 11, whereby step ii) further comprises:
1. before the measurement of the sample to be measured:
a) rotating the rotatable tray to position the sample to be measured in front of the end effector of the telescopic arm; and
b) picking the sample to be measured with the end effector of the telescopic arm and placing it into the X-ray analysis device;
2. starting the measurement of the sample to be measured;
3. during the measurement of the sample to be measured, rotating the rotatable tray to a position of a subsequent sample to be measured, picking the subsequent sample and putting it into the first free position next to the input slot;
4. after the measurement of the sample to be measured, which becomes the last measured sample:
a) picking the last measured sample from the X-ray analysis device and positioning it in the second position on the second side of the input slot;
b) rotating the rotatable tray to the first side of the input slot, picking the subsequent sample, which becomes the sample to be measured, and placing it into the X-ray analysis device; and
c) rotating the rotatable tray to the second position on the second side of the input slot, picking the last measured sample and putting it into a different free position on the rotatable tray;
5. Repeat steps 2) to 4) until every sample is measured.

13. The method according to claim 12, further comprising, prior to step ii) 1), clearing a measurement position inside the X-ray analysis device when it is occupied by a sample other than the sample to be measured by picking the sample in the measurement position and putting it into a free position on the rotatable tray.

14. The method according to claim 12, further comprising, following step ii)3):3.1) if a sample position next to a first side of the input slot is not free, rotating the rotatable tray to that sample position, picking a sample in that position and putting it into a different free sample position on the rotatable tray.

15. The method according to claim 12, further comprising, following step ii)3):
3.2): if the sample position next to a second side of the input slot is not free, rotating the rotatable tray to that sample position, picking the sample in that position and putting it into a different free sample position on the rotatable tray.
